(19) United States
(12) Patent Application Publication
(10) Pub. No.: US 2004/0239011 A1
(43) Pub. Date: Dec. 2, 2004

(54) Method of manufacturing exhaust gas purifying filter

(75) Inventor: Mikio Ishihara, Kariya-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, AICHI-PREF. (JP)

(21) Appl. No.: 10/830,086

(22) Filed: Apr. 23, 2004

(30) Foreign Application Priority Data
May 30, 2003 (JP) 2003-154876

(51) Int. Cl. C04B 33/32

(52) U.S. Cl. 264/628; 264/630; 264/634; 264/44

(57) ABSTRACT

Method of manufacturing an exhaust gas purifying filter capable of purifying an exhaust gas. The manufacturing method comprises a die setting step wherein a tapered jig (3) having a plurality of tapered molding surfaces (31) is disposed in opposition to a molding die (2) having slits (21), and wherein the tapered molding surfaces (31) are positioned so as to be aligned with the slits (21); a tapered plug formation step wherein the molding material is extruded from the slits (21) to form honeycomb-like molded article 10 while the front end thereof is introduced into the tapered jig (3) and the front end (13) of the partition (11) is deflected along the tapered molding surface (21) to form a tapered plug (15); a jig movement step wherein the tapered jig (3) is moved in the extrusion direction; a cutting step wherein the honeycomb-like molded article (10) is cut at a predetermined length; and a plug fitting step wherein the cut molded article (10) is dried and fired, and then plugs are fitted into the small openings (14) at the front end and into the openings of the cells (12) at the rear end.

### BACKGROUND OF THE INVENTION

1. Field of the Invention

The present invention relates to a method of manufacturing an exhaust gas purifying filter capable of capturing particulates in an exhaust gas, discharged from an internal combustion engine and the like, to thereby purify the exhaust gas.

2. Description of the Related Art

Hitherto, there have been used exhaust gas purifying filters which capture particulates in exhaust gases discharged from internal combustion engines such as diesel engines to thereby purify the exhaust gas. Such an exhaust gas purifying filter typically comprises, as shown in FIGS. 1 and 2, a honeycomb structure 90 in which plug members 94 are provided at one end of each cell 92.

When exhaust gas 4 is cleaned using the exhaust gas purifying filter 9, as shown in FIG. 2, the exhaust gas 4 is introduced from an opening 93 of a cell 92 at one end surface 991 of the exhaust gas purifying filter 9. The exhaust gas 4 introduced into the cell 92 passes through the partitioning wall 91 to the adjacent cell 92. At this time, the particulates in the exhaust gas 4 are captured by the partitioning wall 91, and as a result, the exhaust gas is cleaned. Further, using the partitioning wall 91 having carried thereon a catalyst, for example, the captured particulates can be decomposed and removed as a result of a catalytic reaction.

The cleaned exhaust gas 4 is discharged from an opening 93 of the cell 92 at the other end surface 992 of the exhaust gas purifying filter 9.

Thus, cleaning of the exhaust gas 4 can be accomplished using the exhaust gas purifying filter 9.

However, in the exhaust gas purifying filter 9 having the above construction, as plug members 94 are disposed in half of cells 92 at the inlet side end surface 991 of the filter 9, particulates in the exhaust gas 4 tend to easily accumulate and deposit on the end surface 991 and the particulates may also cover the openings 93 having no plug fitted thereon, thereby causing clogging. As a result, a pressure drop, in the exhaust gas 4, may occur in the exhaust gas purifying filters, and also smooth introduction and discharge of the exhaust gas 4 may become difficult.

In order to solve the problems described above, PCT International Patent Publication (Kohyo) No. 8-508199 teaches a filter 8 in which partitioning walls 81 are deformed so as to block one end of the cell 82, as shown in FIG. 3.

The filter 8 is constructed such that the partitioning wall 81 is deformed, near one end thereof, to tapered shape so as to block the one end of the cell 82, and at the same time to widen the opening of the adjacent cell 82. Thus, the deposition of particulates at the end surface of the inlet port side can be avoided and a pressure drop, in the exhaust gas 4, can be kept small so that the exhaust gas 4 may be introduced and discharged smoothly.

However, as the deformation of the partitioning wall 81 has to be performed on the honeycomb-like molded article which has been produced upon extrusion molding and drying, a large pressing force must be applied to the end portion of the partitioning wall 81. It is therefore difficult to deform the partitioning wall 81 smoothly into a desired shape.

A deformation method is also disclosed in the above-cited PCT Kohyo No. 8-508199, in which the end portion of the partitioning wall 81 is subjected to a soaking process in order to bring it to an easily deformable state and, then, the partitioning wall 81 is pressed and deformed into the desired shape. Specifically, the end portion of the partitioning wall 81 is immersed in a soaking liquid such as water, a water and ethanol, a mixture water and oil emulsion, or the like, for 2 to 10 minutes, for example, followed by deforming the end portion.

However, in this method, there arises a problem that a new step of soaking is additionally required and that, as the soaking process is time-consuming, production efficiency is unavoidably lowered.

### SUMMARY OF THE INVENTION

It is an object of the present invention to solve the above-described prior art problems by providing a method of manufacturing an exhaust gas purifying filter, which permits the filter to be manufactured easily and with excellent production efficiency, while ensuring smooth introduction and discharge of the exhaust gas.

According to the present invention, there is provided a method of manufacturing an exhaust gas purifying filter capable of capturing particulates in an exhaust gas, discharged from an internal combustion engine, to thereby purify the exhaust gas, which comprising the steps of:

setting a molding die wherein a tapered jig having a plurality of tapered molding surfaces formed in tapered shape so as to be inclined relative to an extrusion direction of the filter-providing molding material, particularly ceramic material, is disposed in opposition to an extrusion port consisting of opened slits in a molding die, the slits being formed in the shape of honeycomb, and the plurality of tapered molding surfaces are positioned so as to be aligned with the slits of the molding die in the extrusion direction of the molding material;

forming tapered plugs wherein the molding material is extruded from the slits of the molding die so as to form a honeycomb-like molded article having a plurality of cells separated by partitions, the front end of the honeycomb-like molded article is introduced into the tapered jig, and then, by deflecting the front end of the partitions along the plurality of tapered molding surfaces of the tapered jig, a plurality of tapered plugs having small openings are formed, the small openings being produced by size reduction of the openings of the cells;

moving the tapered jig wherein the tapered jig is moved in the extrusion direction of the molding material at a speed equal to or higher than the extrusion speed of the molding material;

cutting the molded article wherein, after the molding material is extruded at a predetermined extrusion length, the honeycomb-like molded article is cut at a predetermined length; and

fitting plugs wherein, after cutting, the honeycomb-like molded article is dried and fired, and then plugs are fitted into the small openings at the front end of the molded article and into the openings of the cells at the rear end of the molded article.

Next, functions and effects of the manufacturing method according to the present invention will be described.

In accordance with the manufacturing method of the present invention, the tapered plugs are formed during extrusion molding for the honeycomb-like molded articles. That is, the tapered plugs are formed at the front end of the honeycomb-like molded article using the tapered jig disposed in opposition to the extrusion port of the molding die which may be briefly called a “mold” or a “die”. Therefore, the front end portion of the partitioning walls (partitions) of the honeycomb-like molded article extruded from the molding die can be deflected while the molded article is not yet hardened and is still soft.

Therefore, the partitions can be easily deformed without imposing an undue load on the honeycomb-like molded article.

Further, in forming the tapered plugs, as neither heating of the tapered jig nor soaking of the front end of the partitions of the honeycomb-like molded article is required, production efficiency can be remarkably improved.

Furthermore, in the die setting step, as the molding die and the tapered jig are both precisely machined tools, and they are positioned relative to each other, positioning of these tools can be always performed with a high precision and with a high reproducibility. Moreover, in the present invention, as positioning of the tapered jig needs not be performed at the end surface of the honeycomb-like molded article where a small deformation is likely to be produced, occurrence of a positional deviation of the partitions of the honeycomb-like molded article from the tapered molding surfaces can be eliminated. Precision in the formation of the tapered plugs in the tapered plug formation step can be improved, accordingly.

Furthermore, as the tapered jig has a plurality of tapered molding surfaces, a plurality of tapered plugs can be simultaneously formed at the opening of a plurality of cells at one time. Thus, the production efficiency or yield of the exhaust gas purifying filter can be improved, and at the same time, variability of the shape of the resulting tapered plugs between the plurality of cells can be inhibited.

In addition, the exhaust gas purifying filter obtained according the above manufacturing method has the tapered plugs at one end thereof. Adjacent to the opening where the tapered plug is provided, a large-sized opening, that is widened to the end, i.e., opened widely, is formed. The large-sized opening is called herein a “large opening”. Therefore, when the end surface provided with the tapered plug, that is, the end surface where the large opening is formed, is disposed to face the introduction side of the exhaust gas, accumulation of particulates in the exhaust gas on the filter can be prevented, and thus pressure drop of the exhaust gas can be suppressed and the exhaust gas can be introduced and discharged smoothly.

As described above, according to the present invention, a method of manufacturing an exhaust gas purifying filter can be provided which permits the exhaust gas to be introduced and discharged smoothly and which can be easily performed with an excellent production efficiency.

### BRIEF DESCRIPTION OF THE DRAWINGS

FIG. 1 is a perspective view showing an exhaust gas purifying filter according to the prior art method;

FIG. 2 is a cross-sectional view showing the exhaust gas purifying filter according to the prior art method;

FIG. 3 is a cross-sectional view showing another exhaust gas purifying filter according to the prior art method;

FIG. 4 is a cross-sectional view showing the die setting step in a method of manufacturing an exhaust gas purifying filter according to Example 1;

FIG. 5 is a cross-sectional view showing the tapered plug formation step in the method of manufacturing an exhaust gas purifying filter according to Example 1;

FIG. 6 is a cross-sectional view showing the jig movement step in the method of manufacturing an exhaust gas purifying filter according to Example 1;

FIG. 7 is a cross-sectional view showing the tapered jig in Example 1 and corresponds to the section taken along the line A-A of FIG. 8 as seen from the direction of the arrows;

FIG. 8 is a plan view showing the tapered jig, on the side of the tapered molding surfaces, used in Example 1;

FIG. 9 is a plan view showing the slits of the molding die used in Example 1;

FIG. 10 is a schematic view explaining the positional relation between the tapered molding surfaces and the slits in Example 1;

FIG. 11 is a cross-sectional view explaining the cross-section of the exhaust gas purifying filter in Example 1;

FIG. 12 is a front view showing the exhaust gas purifying filter in Example 1 as seen from the tapered plug formation side;

FIG. 13 is a cross-sectional view showing the tapered jig according to Example 2 and corresponds to the section taken along the line B-B of FIG. 14 as seen from the direction of the arrows;

FIG. 14 is a plan view showing the tapered jig in Example 2 as seen from the tapered molding surfaces;

FIG. 15 is a plan view showing the slits of the molding die in Example 2;

FIG. 16 is a schematic view explaining the positional relation between the tapered molding surfaces and the slits in Example 2; and

FIG. 17 is a front view showing the exhaust gas purifying filter in Example 2 as seen from the tapered plug formation side.

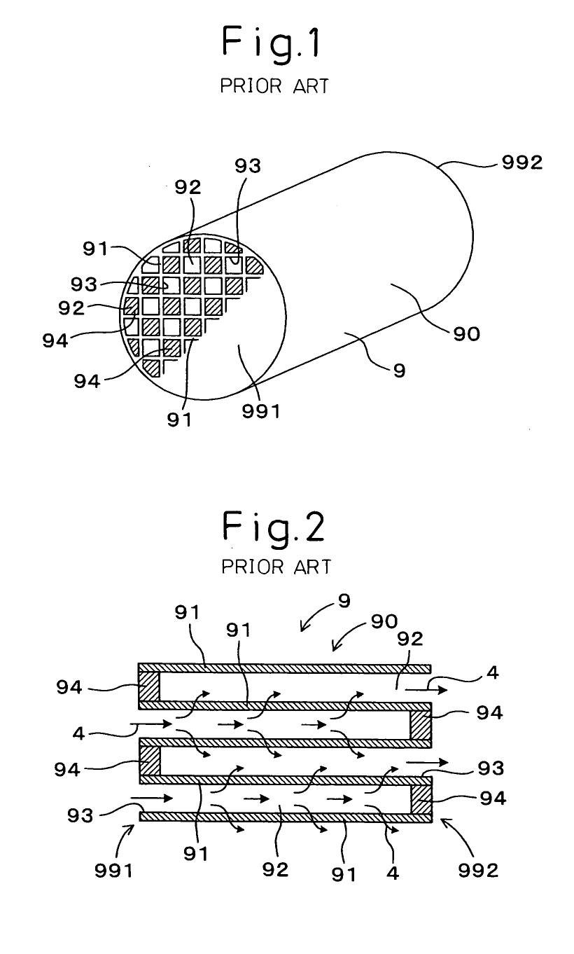

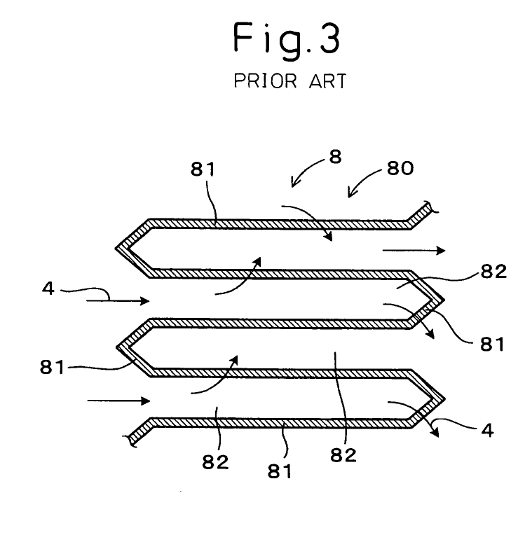

### DESCRIPTION OF THE PREFERRED EMBODIMENTS

In the practice of the present invention, the exhaust gas purifying filter can be applied to purify the exhaust gas from wide variety of apparatuses, typically internal combustion engines. The internal combustion engines include, for example, a diesel engine or the like.

Plug-fitting in the finishing step of the present manufacturing method may be performed before firing of the honeycomb-like molded article, followed by simultaneously firing the honeycomb-like molded article and the plugs. Alternatively, plug-fitting may be performed after firing of the honeycomb-like molded article, followed by firing the plugs.

With regard to the honeycomb-like molded article, it should be noted that the terms “front end” of the honeycomb-like molded article or “front end portion” of the partitions, as used herein, are intended to mean that the word “front” refers to the side in the extrusion direction of the molding material applied for the formation of the filter, typically ceramic material. In the honeycomb-like molded article (unit honeycomb body) obtained upon cutting in the cutting step, the term “rear end” refers to the end on the opposite side of the front end of the unit honeycomb body.

In the manufacturing method of the present invention, the movement of the tapered jig in the jig movement step is preferably performed in synchronism with the extrusion of the molding material.

In this case, extrusion molding of a honeycomb-like molded article can be performed while the tapered plugs as formed using the tapered jig are held by the tapered jig. Therefore, deformation of the tapered plugs formed in the tapered plug formation step before drying and firing steps can be prevented with a high reliability.

Further, the tapered jig is preferably provided, at positions facing the portion where the small openings are to be formed, protrusions projecting toward the molding die.

In this case, the small openings can be easily and reliably formed. Further, by providing the small openings, formation of a closed space between the molding die and the partitions can be prevented during extrusion molding of the honeycomb-like molded article, thereby preventing deformation of the partitions.

That is, assuming that any closed space is formed between the molding die and the partitions, negative pressure is created in the closed space when the volume of the space increases during extrusion molding, and as a result, the partitions may be deformed. However, by providing the protrusions to the tapered jig as described above, formation of the closed space can be prevented and thus deformation of the partitions can be prevented.

Furthermore, it is preferred that the tapered jig has through-holes formed therein which are penetrated from the portion facing the opening of each cell of the honeycomb-like molded article to a surface of the tapered jig other than the surface opposed to the honeycomb-like molded article.

In this case, deformation of the partitions of the honeycomb-like molded article in the jig movement step can be prevented. Thus, when the tapered jig is moved in synchronism with extrusion of the molding material, formation of closed space between the tapered jig, the partitions and the molding die can be prevented and thus deformation of partitions can be prevented. Further, when the tapered jig is moved at a speed higher than the extrusion speed of the molding material, negative pressure that is otherwise produced in the space between the tapered jig, the partitions and the molding die is not produced and thus deformation of partitions can be prevented.

### EXAMPLES

The present invention will be further described with reference to the examples. Note, however, that the present invention should not be restricted to these examples

### Example 1

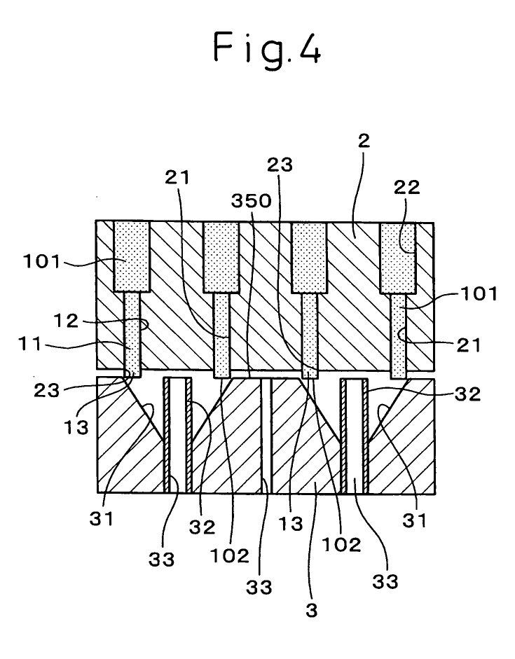

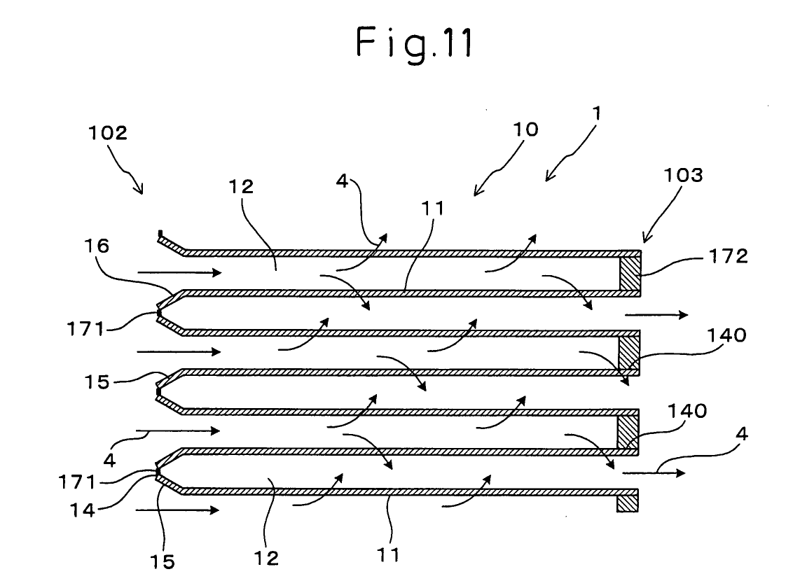

A method of manufacturing an exhaust gas purifying filter according to the present invention will be described with reference to FIGS. 4 to 12. Note that the exhaust gas purifying filter 1 produced in the present example is used for cleaning of exhaust gas 4 by capturing particulates in the exhaust gas 4 discharged from an internal combustion engine, as shown in FIG. 11.

In the manufacturing method of an exhaust gas purifying filter, there is subsequently carried out a die setting step, a tapered plug formation step, a jig movement step, a cutting step and a plug fitting step.

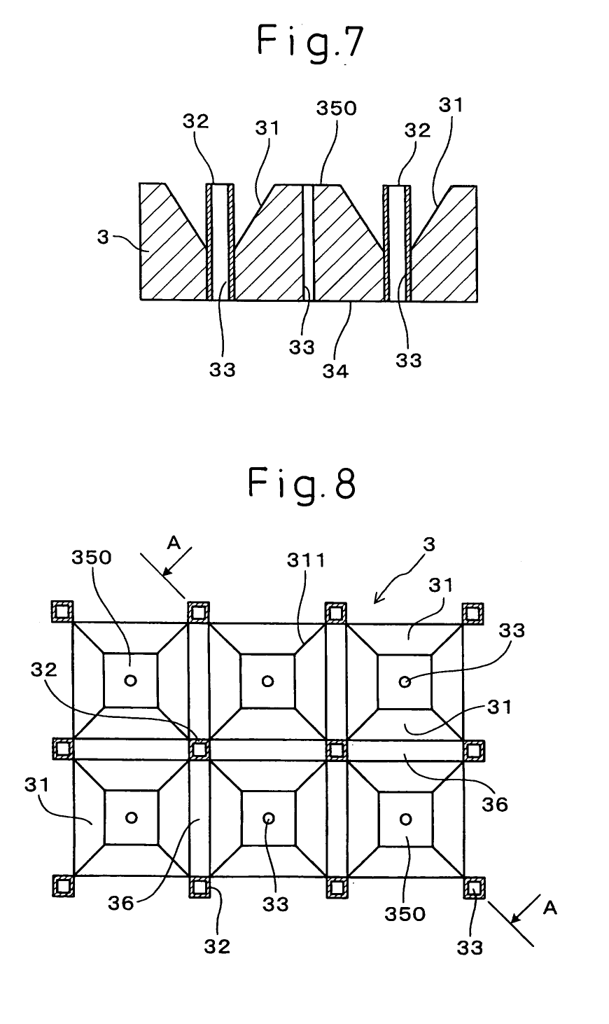

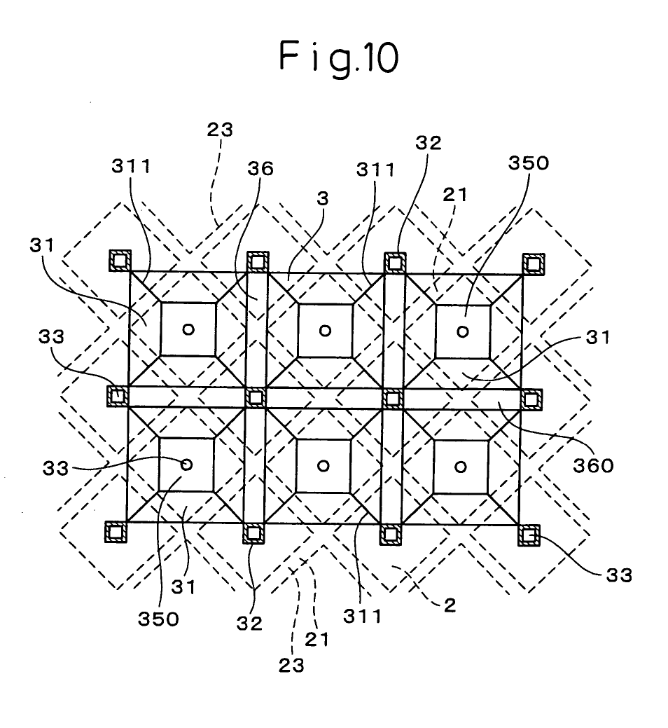

In the molding die setting step, as shown in FIG. 4, a tapered jig 3 having a plurality of tapered molding surfaces 31 formed so as to have a taper inclined in the extrusion direction of the molding material as shown in FIGS. 7 and 8 is disposed in opposition to an extrusion port 23 formed upon opening of honeycomb-like slits 21 in a molding die 2. In the illustrated construction, as shown in FIGS. 4 and 10, the plurality of tapered molding surfaces 31 are positioned so as to be aligned with the slits 21 of the molding die 2 in the extrusion direction of the molding material. The molding material used herein is a ceramic material.

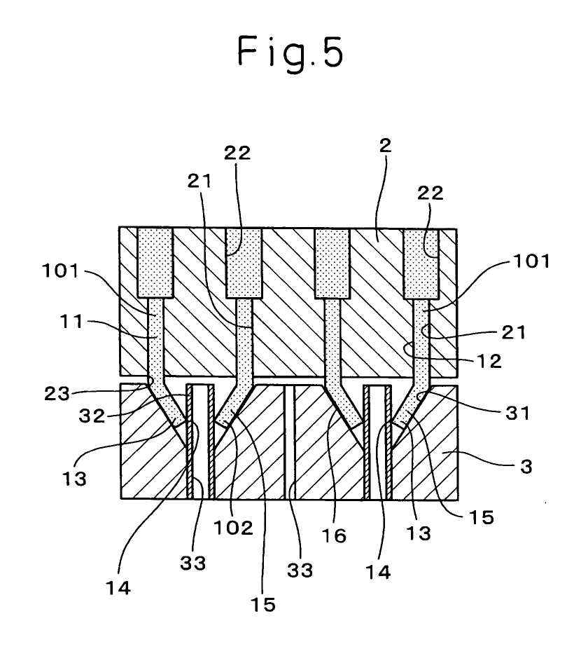

In the subsequent tapered plug formation step, first, as shown in FIG. 4, a ceramic material 101 as the molding material is extruded from the slits 21 of the molding die 2. During extrusion, a honeycomb-like molded article 10 having a plurality of cells 12 separated by partitions 11 is shaped, while the front end 102 of the molded article 10 is introduced into the tapered jig 3. Then, as shown in FIG. 5, the front end portion 13 of the partitions 11 is deflected along the plurality of tapered molding surfaces 31 in the tapered jig 2 to form a plurality of tapered plugs 15 having small openings 14 are formed. The small openings 14 are produced by reducing a size of the opening of the cells 12.

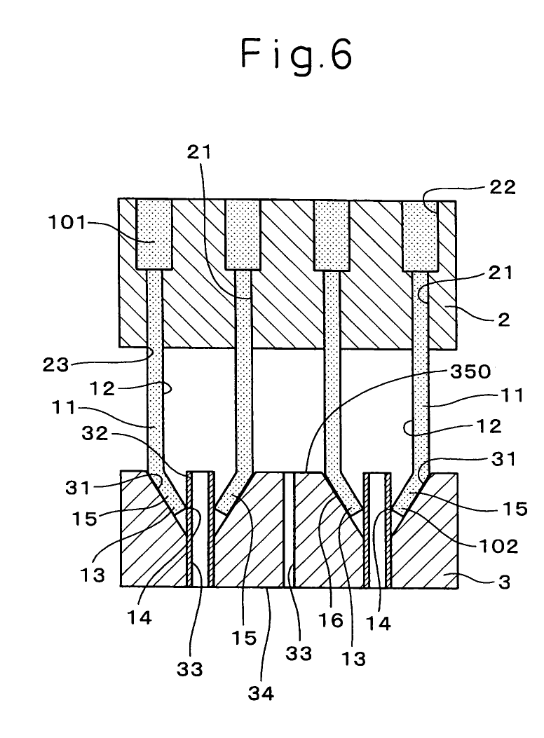

After completion of the plug formation step, in the jig movement step, as shown in FIG. 6, the taper jig 3 is moved in the extrusion direction at the same speed as the extrusion speed of the ceramic material 101.

In the subsequent cutting step, after the ceramic material 101 is extruded to a predetermined length, the resulting honeycomb-like molded article 10 is cut at a predetermined length in conformity with the desired configuration and size of the exhaust gas purifying filter.

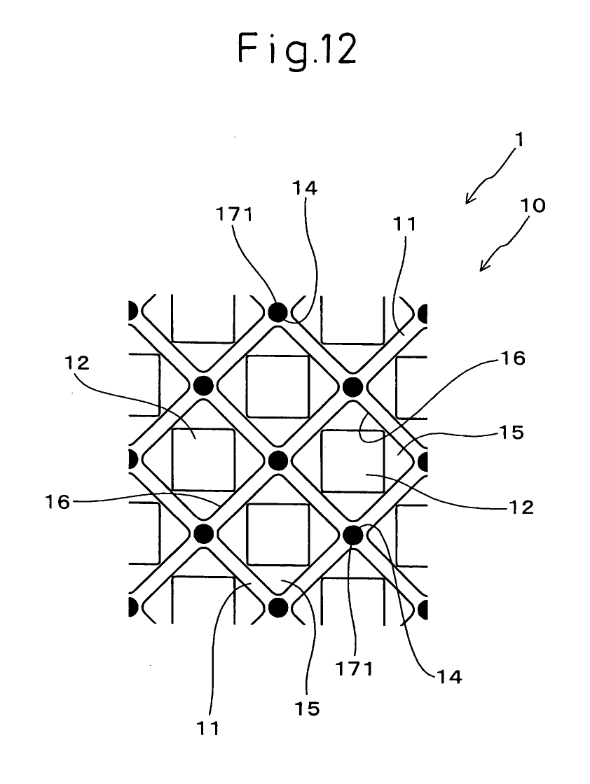

In the final plug fitting step, the cut molded article 10 is dried and fired and, as shown in FIGS. 11 and 12, plug fitting is performed by applying plug members 171 and 172 in the small openings 14 at the front end 102 of the cells 12 and in the openings 140 at the rear end 103 of the cells 12 in the honeycomb-like molded article 10, respectively.

Referring again to the jig movement step, the movement of the tapered jig 3 is performed in synchronism with the extrusion of ceramic material 101. Thus, as shown in FIG. 6, the extrusion molding of the honeycomb-like molded article 10 is performed while supporting the tapered plug 15 by the tapered jig 3.

As shown in FIGS. 4 to 8, the tapered jig 3 further comprises, at positions facing the portion where the small openings 14 are to be formed, protrusions 32 projecting in the direction toward the molding die 2.

Further, the tapered jig 3 has through-holes 33 formed therein. The through-holes 33 are extending from the portion facing the opening of each cell 12 of the honeycomb-like molded article 10 to a surface of the tapered jig 3 other than the surface opposed to the molded article 10. The through-holes 33 include both those penetrating from the tip of the protrusion 32 to the rear surface 34 (the surface opposite to the surface facing the molding die) and those penetrating from top surface 350 to the rear surface of the tapered jig 3. Therefore, the protrusion 32 has a substantially tubular shape.

Furthermore, the tapered jig 3 has a plurality of tapered molding surfaces 31 in conformity with the shape of the honeycomb-like molded article 10, as shown in FIGS. 7 and 8. Thus, the size, pitch and the like of the tapered molding surfaces 31 are determined to ensure that the front end 13 of the partitions 11 of the honeycomb-like molded article 10 extruded from the molding die 2 is always introduced into the tapered molding surface 31. Although only a portion of the tapered jig 3 is shown in FIGS. 7 and 8, the tapered jig 3 is formed in such a size that the tapered jig 3 is opposed to the entire surface of the front end 102 of the honeycomb-like molded article 10.

Moreover, in the tapered jig 3, the tapered molding surfaces 31, as shown in FIG. 8, are formed such that they radiate from each edge of a square top surface 350 on all sides. Further, substantially straight grooves 36 are formed in the shape of a lattice, and protrusions 32 are disposed at the intersections of the grooves 36.

Next, the method of manufacturing the exhaust gas purifying filter 1 will be described more specifically below.

First, in the die setting step, as shown in FIGS. 4 and 10, the tapered jig 3 is disposed so as to be in proper position relative to the extrusion port 23 of the molding die 2. More specifically, corners 311 of the plurality of tapered molding surfaces 31 are positioned so as to be aligned with the slits 21 of the molding die 2 in the extrusion direction of the molding material 101.

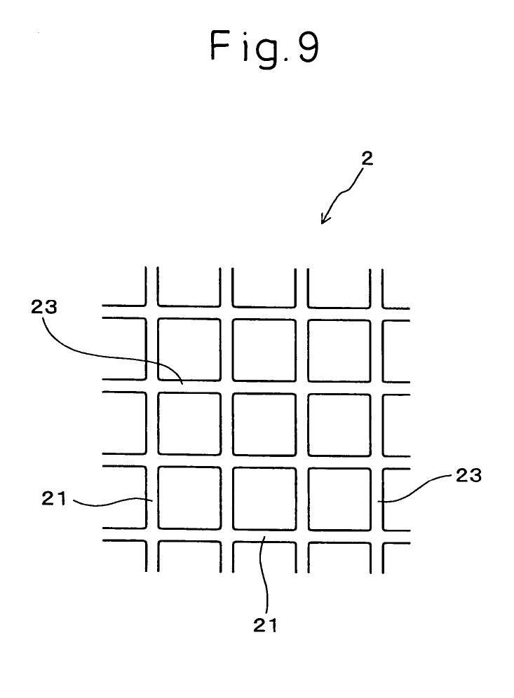

As shown in FIG. 9, the slits 21 are formed in the pattern of a substantially square lattice.

As described above, a ceramic material is preferably used as a molding material. Examples of suitable ceramic material include, but are not restricted to, talc, silica, kaolin, alumina, aluminium hydroxide, etc. Preferably, a pore-providing material such as carbon, resin, etc. is used in a predetermined amount in combination with the ceramic material. These materials are preferably blended to obtain a cordierite composition. Then, an organic binder and water are added to this composition, and are mixed and kneaded to obtain a clay-like material.

In the practice of the present invention, the ceramic material may contain a thermoplastic resin, for example, acrylic resin, poly(methyl stearate) resin, vinyl chloride resin, etc. Further, as the organic binder, methyl cellulose, hydroxy methyl cellulose, etc., may be used.

Next, in the tapered plug formation step, a honeycomb-like molded article 10 can be produced upon extrusion molding by using a extruder (not shown). In the extruder, the ceramic material 101 in the form of a clay-like material is extruded, from the extrusion port 23 of the molding die 2 as a honeycomb of substantially square shape in section. That is, the ceramic material 101 is introduced from the supply port 22 of the molding die 2 into the slits 21 and is extruded to obtain a honeycomb-like molded article 10. An extruder disclosed in Japanese Patent Application No. 2002-289130, for example, may be used as the extruder.

As shown in FIG. 4, the front end 102 of the honeycomb-like molded article 10 extruded from the extrusion port 23 of the molding die 2 is introduced into the tapered molding surfaces 31 of the tapered jig 3 which has been positioned and aligned as described above. As shown in FIG. 5, the front end 13 of the partition 11 of the molded article 10 introduced into the tapered molding surfaces 31 is deflected obliquely along the tapered molding surface 31. When viewed from the front in the extrusion direction, the front end 13 is deflected substantially at a right angle as shown in FIG. 12, because corner 311 of the tapered molding surface 31 shown in FIG. 10 is pressed against the front end 13. The honeycomb-like molded article 10 is soft at this time, and thus can be easily deflected.

The front end 13 of the partition 11, as shown in FIG. 5, abuts the side of the protrusion 32 of the tapered jig 3. Thus, it becomes possible to form the tapered plug 15, and at the same time, to form a small opening 14 at the front end 102 thereof.

Further, as shown in FIGS. 11 and 12, since the partition 11 is widened in the cell 12 adjacent to the cell 12 which forms the tapered plug 15, the opening of the cell 12 is widened so as to form a large opening 16.

Next, the jig movement step starts at the moment when the front end 13 abuts the protrusion 32 of the tapered jig 3 (at the state shown in FIG. 5). That is, when the front end 13 abuts the protrusion 32, the tapered jig 3 begins to move relative to the molding die 2 and in the extrusion direction at speed substantially equal to that of extrusion. Thus, as shown in FIG. 6, the honeycomb-like molded article 10 is extrusion-molded, while the tapered plug 31 is in contact with the tapered molding surface 15.

During this step, since the internal space of the cell 12 having tapered plug 15 formed at the front end thereof is in communication with the exterior via the through-hole 33 formed in the tapered jig 3, no closed space is produced so that deformation of the partition 11 can be prevented.

Then, in the subsequent cutting step, when the honeycomb-like molded article 10 is extruded to a predetermined length (for example, 150 mm), the molded article 10 is cut at the extrusion port 23 of the molding die 2 in the section perpendicular to the extrusion direction. A honeycomb-like molded article 10 having the tapered plug 15 at the front end 102 thereof is thus obtained.

Note that, if the tapered jig 3 is again disposed at the extrusion port 23 of the molding die 2, and then the die setting step (FIG. 4), tapered plug formation step (FIG. 5), jig movement step (FIG. 6) and cutting step are repeated, it becomes possible to obtain a plurality of honeycomb-like molded articles 10 having the same structure and size.

Thereafter, in the plug fitting step, the resulting honeycomb-like molded article 10 is dried and fired, and then plug members 171 and 172 are fitted, respectively, to the small opening 14 formed by the tapered plug 15 and to the opposite opening 140 of the adjacent cell 12 in which a large opening 160 has been formed.

Drying and firing of the honeycomb-like molded article 10 may be performed, after the plug fitting has been completed, in conjunction with drying and firing of the plug members 171, 172.

As a result of a series of the above steps, an exhaust gas purifying filter 1 consisting of the honeycomb-like molded article 10 which has a plurality of cells 12 of substantially square shape in section and provided with the tapered plug 15 at one end, as shown in FIG. 11, can be obtained.

As shown in FIG. 11, the exhaust gas purifying filter 1 is used in such a manner that the front end 102 comprising the tapered plugs 15 and the large openings 16 is disposed facing the upstream side of the exhaust gas 4. With this construction, the exhaust gas 4 discharged from an internal combustion engine such as a diesel engine is introduced via the large openings 16 into the cells 12. Herein, the cells 12 are closed at the other end with the plug member 172, and the partitions 11 are porous bodies having a plurality of fine pores.

Therefore, as shown in FIG. 11, the exhaust gas 4 introduced into the cells 12 passes through the partitions 11. At this time, particulates such as carbon particles are captured by the partitions 11, and thus the exhaust gas 4 is purified. The particulates captured by the partitions 11 are decomposed by the function of the catalyst carried by the partitions 11, and removed.

Next, functions and effects of the present example will be described.

In the manufacturing method as described above, as shown in FIG. 5, forming of the tapered plug 15 is performed at the time of extrusion molding of the honeycomb-like molded article 10. Thus, the tapered plug 15 is formed at the front end 102 of the molded article 10 by the tapered jig 3 which is disposed in opposition to the extrusion port 23 of the molding die 2. Thus, the front end 13 of the partitions 11 of the molded article 10 extruded from the molding die 2 can be deflected, while the molded article 10 is still in a soft state. Therefore, the partitions 11 can be deformed without imposing undue load upon the molded article 10.

In addition, since neither heating of the tapered jig 3 nor soaking of the front end 13 of the partitions 11 of the honeycomb-like molded article 10 is not required for the formation of the tapered plug 15, a production efficiency can be improved.

In the above-described die setting step, when the molding die 2 and the tapered jig 3 are positioned relative to each other, since these tools are both precisely machined tools, the positioning of these tools can be always performed with a high precision and with a high reproducibility. Moreover, in the present invention, as the positioning of the tapered jig 3 need not be performed relative to the end surface of the honeycomb-like molded article 10 where a small deformation is likely to be produced, occurrence of positional deviation of the partitions 11 of the molded article 10 from the tapered molding surfaces 31 can be eliminated. Precision in forming the tapered plug 15 in the tapered plug formation step can thus be improved.

Since the tapered jig 3 has a plurality of tapered molding surfaces 31, a plurality of tapered plugs 15 can be produced, batchwise, at the opening of a plurality of cells at once. Thus, the production efficiency of the exhaust gas purifying filter 1 can be improved, and at the same time, a variability of shape of the tapered plugs 15 between the plurality of cells 12 can be diminished.

The exhaust gas purifying filter 1 obtained by the manufacturing method as described above has the tapered plugs 15 at one end thereof. Adjacent to the opening where the tapered plug 15 is provided, a large opening 16 that is opened widely is formed.

Therefore, as shown in FIG. 11, by disposing the end surface provided with the tapered plug 15, that is, the end surface having formed therein the large opening 16, in opposition to the introduction side of the exhaust gas 4, accumulation of particulates in the exhaust gas 4 can be prevented, pressure drop of the exhaust gas 4 can be suppressed and also the exhaust gas 4 can be introduced and discharged smoothly.

Since movement of the tapered jig 3 in the jig movement step is performed in synchronism with the extrusion of the ceramic material 101, extrusion molding of a honeycomb-like molded article 10 can be performed while the tapered plugs 15 as formed by the tapered jig 3 are held by the same tapered jig 3. Therefore, deformation of the tapered plugs 15 formed in the tapered plug formation step can be completely prevented, before the drying and firing steps.

Further, as the tapered jig 3 comprises the protrusions 32, the small openings 14 can be easily and reliably formed as shown in FIG. 5. By providing the small openings 14, formation of the closed space between the molding die 2 and the partitions 11 at the time of extrusion molding of the honeycomb-like molded article 10 can be prevented. Deformation of the partitions 11 can be thus prevented.

That is, if the closed space is formed, negative pressure is produced in this closed space when the volume of this space increases at the time of extrusion molding of the honeycomb-like molded article 10, and as a result, the partitions 11 may be deformed. Contrary to this, by providing the protrusions as described above, formation of the closed space can be prevented and thus deformation of the partitions 11 can be prevented.

Moreover, as the tapered jig 3 has through-holes 33 formed therein, deformation of the partitions 11 of the honeycomb-like molded article 10 in the jig movement step can be prevented as shown in FIG. 5. That is, when tapered jig 3 is moved in synchronism with extrusion of the ceramic material 101, formation of the closed space between the tapered jig 3, partitions 11 and the molding die 2 can be prevented and, thus, deformation of the partitions 11 can be prevented.

As can be appreciated from the above descriptions, according to the present example, a method, of manufacturing an exhaust gas purifying filter which permits exhaust gas to be introduced and discharged smoothly and which can be easily manufactured at an excellent production efficiency, can be provided.

### Example 2

In accordance with the present example, the jig movement step, in which the taper jig 3 is moved at speed higher than the extrusion speed of the ceramic material 101 is explained.

For this purpose, in the tapered plug formation step (FIG. 5), after the tapered plugs 15 are formed, the tapered jig 5 is separated from the tapered plug 15. Other conditions and others in this example are the same as those of Example 1.

In this example, the tapered jig 3 need not be moved in synchronism with the extrusion of the ceramic material 101, so that the manufacture is simplified.

Further, as through-holes 33 are formed in the tapered jig 3, when the tapered jig 3 is separated from the honeycomb-like molded article 10, negative pressure is not produced in the space between the tapered jig 3, the partitions 11 and the molding die 2, and thus the possibility of deformation of the partitions can be eliminated.

In addition, the functions and effects similar to those of Example 1 can be obtained in this example.

### Example 3

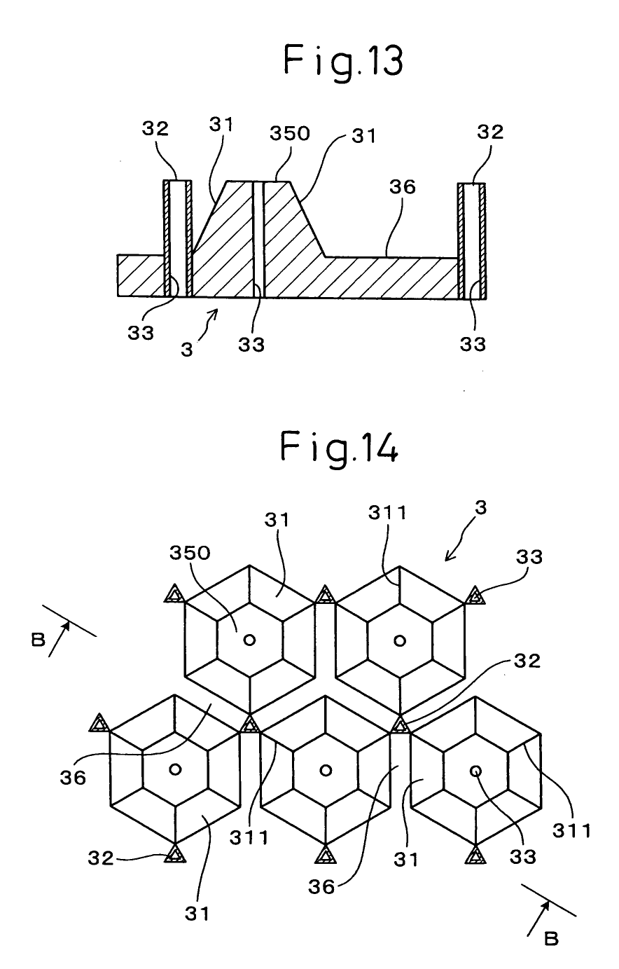

The present example is an example of the method of manufacturing an exhaust gas purifying filter 1 consisting of a honeycomb-like molded article 10 having cells 12 of substantially triangular shape in cross-section as shown in FIG. 13 to 17.

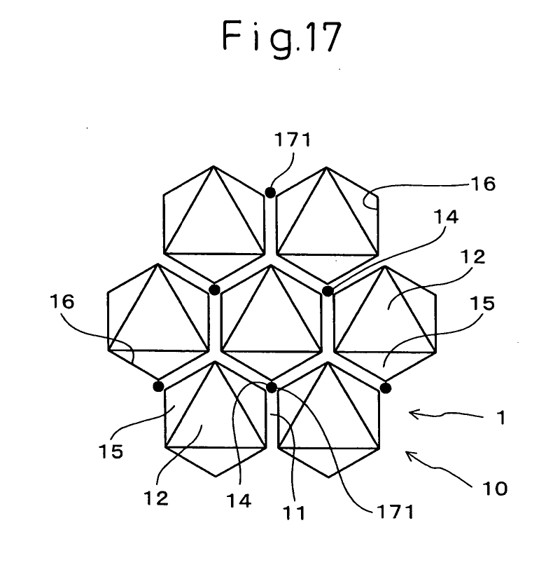

In the exhaust gas purifying filter 1, as shown in FIG. 17, the tapered plugs 15 are formed with adjacent large opening 16. The large opening 16 is of substantially hexagonal shape in section as viewed from the front.

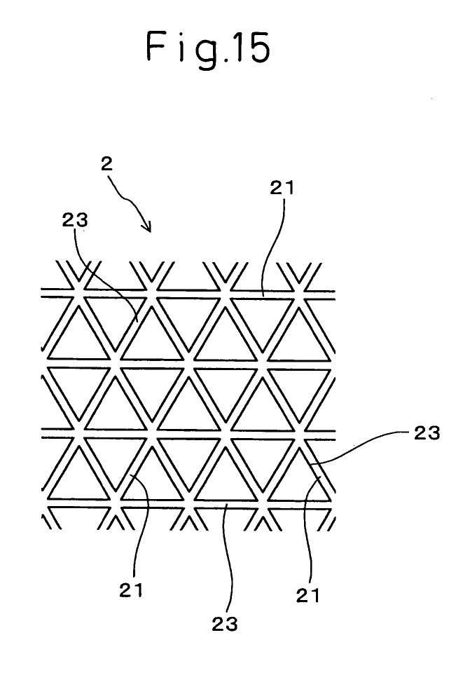

The method of manufacturing an exhaust gas purifying filter 1 of this example is basically the same as that of Example 1, except that shape of the molding die 2 and the tapered jig 3 used is different. Thus, as shown in FIG. 15, the molding die 2 has slits 21 formed in the shape of a triangular lattice and, as shown in FIG. 14, the tapered jig 3 has the top surface 350 of substantially regular hexagonal shape, and the tapered molding surfaces 31 are formed so as to radiate in six directions from each edge of the hexagon.

Grooves 36 are formed between the tapered molding surfaces 31, and the protrusions 32 are disposed at the intersections of the grooves 36.

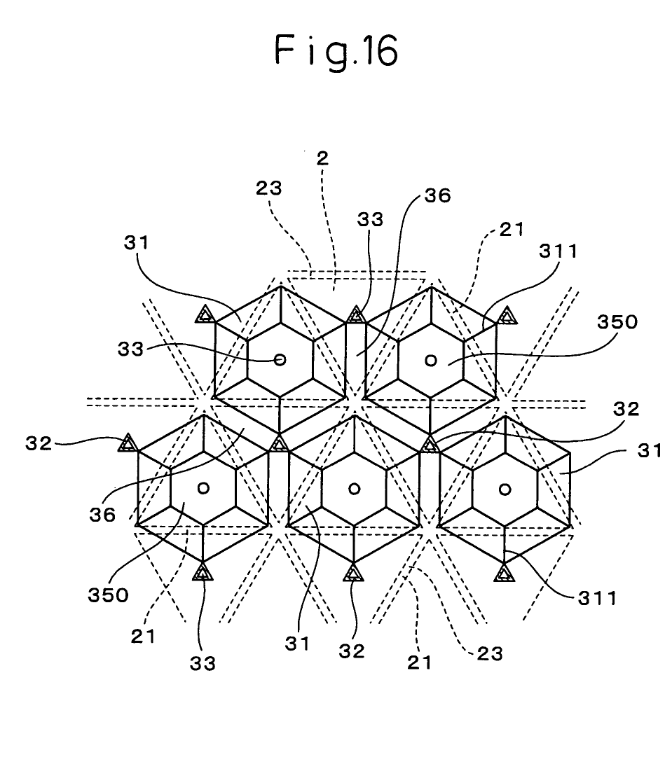

In molding die-setting step (see FIG. 4), when the tapered jig 3 is disposed at the extrusion port 23 of the molding die 2, positioning is carried out in such a manner that, as shown in FIG. 16, the slits 21 of the molding die 2 are aligned with the corners 311 of the tapered molding surface 31 at approximately the center of each edge of the triangle. At this time, the vertices of the triangle of the slits 21 are disposed at the intersections of the grooves 36 where the protrusion 32 is not disposed.

The taper plug formation step (see FIG. 5) is carried out in the above state. Thus, the front end 13 of the partitions 11 of the honeycomb-like molded article 10 is deflected so as to form the tapered plug 15, and at the same time, the large opening 16, substantially hexagonal in shape in a front view, is formed.

Other conditions and others in this example are the same as those of Example 1.

In this example, an exhaust gas purifying filter consisting of a honeycomb-like molded article having substantially triangular cells in section can be easily obtained.

In addition, functions and effects similar to those of Example 1 can be obtained in this example.

1. A method, of manufacturing an exhaust gas purifying filter capable of capturing particulates in an exhaust gas discharged from an internal combustion engine to thereby purify the exhaust gas, said method comprising the steps of:
setting a molding die wherein a tapered jig, having a plurality of tapered molding surfaces formed in tapered shape so as to be inclined relative to an extrusion direction of a filter-providing molding material, is disposed in opposition to an extrusion port consisting of opened slits in a molding die, said slits being formed in the shape of honeycomb, and said plurality of tapered molding surfaces are positioned so as to be aligned with said slits of said molding die in the extrusion direction of the molding material;
forming tapered plugs wherein the molding material is extruded from said slits of the molding die so as to form a honeycomb-like molded article having a plurality of cells separated by partitions, the front end of the honeycomb-like molded article is introduced into said tapered jig, and then, by deflecting the front end of said partitions along said plurality of tapered molding surfaces of the tapered jig, a plurality of tapered plugs are formed in which said plugs have small openings which are produced upon size reduction of the openings of said cells;
moving said tapered jig wherein said tapered jig is moved in the extrusion direction of the molding material at a speed equal to or higher than the extrusion speed of said molding material;
cutting the molded article wherein, after said molding material is extruded at a predetermined extrusion length, said honeycomb-like molded article is cut at a predetermined length; and
fitting plugs wherein, after cutting, the honeycomb-like molded article is dried and fired and then plugs are fitted into said small openings at the front end of the molded article and into said openings of the cells at the rear end of the molded article.

2. A manufacturing method according to claim 1, wherein the movement of said tapered jig in the jig movement step is synchronized with the extrusion of said molding material.

3. A manufacturing method according to claim 1, wherein said tapered jig comprises protrusions, projecting in the direction toward said molding die, at positions opposed the portions used in the formation of said small openings.

4. A manufacturing method according to claim 1, wherein said tapered jig has through-holes formed therein which penetrate, from the portion opposed to the opening of each cell of said honeycomb-like molded article, to a surface of said tapered jig other than the surface opposed to said molded article.

5. A manufacturing method according to claim 1, wherein said molding material is a ceramic material.

6. A manufacturing method according to claim 5, wherein said ceramic material comprises at least one member selected from the group consisting of talc, silica, kaolin, alumina and aluminum hydroxide.

7. A manufacturing method according to claim 5, wherein said ceramic material further comprises a pore-providing material.

8. A manufacturing method according to claim 7, wherein said pore-providing material is carbon, a resin or a mixture thereof.

9. A manufacturing method according to claim 8, wherein said resin is at least one thermoplastic resin selected from the group consisting of acrylic resin, poly(methyl stearate) resin and vinyl chloride resin.

10. A manufacturing method according to claim 5, wherein said ceramic material further comprises an organic binder.

11. A manufacturing method according to claim 10, wherein said organic binder is methyl cellulose, hydroxymethyl cellulose or a mixture thereof.

12. A manufacturing method according to claim 1, wherein said die setting step, said tapered plug formation step, said jig movement step and said cutting step are repeated to produce a plurality of honeycomb-like molded articles having the same structure using one molding die.

13. A manufacturing method according to claim 1, wherein drying and firing of the honeycomb-like molded article are simultaneously carried out with drying and firing of the plugs fitted into the molded article after completion of said plug fitting step.

14. A manufacturing method according to claim 1, wherein said honeycomb-like molded article has cells, the cross-section of which is substantially a triangle.

15. A manufacturing method according to claim 1, wherein said exhaust gas purifying filter is disposed in an exhaust gas conduit from said internal combustion engine in such a manner that the front end, inclusive of said tapered plugs, of said filter is opposed to an upstream side of said exhaust gas conduit.

16. A manufacturing method according to claim 1, wherein the internal combustion engine is a diesel engine.
